(19) United States
(12) Patent Application Publication
(10) Pub. No.: US 2002/0032608 A1
(43) Pub. Date: Mar. 14, 2002

(54) Direct internet advertising

(76) Inventor: Andrew S. Kanter, Califon, NJ (US)

Correspondence Address: Ernest D. Buff, Ernest D. Buff & Associates, LLC, 245 South Street, Morristown, NJ, 07960, US

(21) Appl. No.: 09/909,643

(22) Filed: Jul. 20, 2001

Related U.S. Application Data
(60) Provisional application No. 60/222,404, filed on Aug. 2, 2000.

(51) Int. Cl. G06F 17/60

(52) U.S. Cl. 705/14

(57) ABSTRACT

An advertisement from an Internet server is directed to a subscriber of an Internet Service Provider. When the user accesses the Internet Service Provider, transmission of the advertisement is triggered by an application logic set stored on the server. The advertisement is displayed in a temporary and non-dismissible window on the user's monitor. Ad display occurs whether or not the user's browser is open. Compensation is provided to the user, if the user registers, for receiving the advertisement. User may elect to receive a one-time emailing from the advertiser. Ad display is based on the user's system capacity and access speed. Hence, efficiency of ad loading is maximized. Ads open and close automatically, are of short duration, and remain unobtrusive to the user. The temporary nature of the ads captures the attention of the user, giving each message more impact. Viewer ad impressions are accurately tracked. Billing of advertisers is based on actual ad viewing, not estimated user statistics. Demographic information from registered users permits advertisers to custom tailor ad campaigns and product presentations.

### BACKGROUND OF THE INVENTION

1. Field of the Invention

The present invention relates to a system and method of advertising to a user accessing the Internet regardless of whether or not a browser window is open.

2. Description of the Prior Art

Numerous advertising systems and methods related to computer use have been disclosed by prior art workers. U.S. Pat. No. 5,781,894 to Petrecca, et al. discloses an advertising system adapted for use with personal computers. The system enables sponsors to present advertisements or commercials to a user during periods of waiting-time typically encountered during normal computer use. The Petrecca, et al. system does not involve the use of the Internet.

U.S. Pat. No. 5,933,811 to Angles, et al. discloses a system and method for delivering customized electronic advertisements in an interactive communication system. Upon receiving an advertising request, an advertising provider computer generates a custom advertisement based on a consumer's profile. The custom advertisement is then combined with an offering from the content provider computer and displayed to the consumer. The advertisement provider computer also credits a consumer account, a content provider account and an Internet provider account each time a consumer views a custom advertisement. Furthermore, the advertisement provider computer tracks consumer responses to the customized advertisements.

U.S. Pat. No. 5,937,392 to Alberts discloses an Internet advertising system having a database, a controller, and an ad server operating as part of a web server. The database has advertising campaign information, including identification information and frequency information for how often the ad is to be served. The ad server uses the campaign information from the database to control the relative ratios of serving ads, the distribution of ads throughout the day, and any triggering mechanisms for controlling what ads are served.

U.S. Pat. 5,948,061 to Merriman, et al. discloses a method and apparatus for targeting the delivery of advertisements over a network such as the Internet. Statistics are compiled on individual users and networks and the use of the advertisements is tracked to permit targeting of the advertisements of individual users.

U.S. Pat. No. 5,999,912 to Wodarz, et al. discloses a dynamic advertising scheduling, display, and tracking for the Worldwide Web. The invention includes at least one template web page that has conventional HTML codes defining the format and content of the web page. Special “ad tags” are used to indicate the characteristics of an ad that can be displayed on a web page at the position of the ad tag.

U.S. Pat. No. 6,009,409 to Adler, et al. discloses a system and method for scheduling and controlling delivery of advertising in a communications network. Also disclosed are a communications network and remote computer program employing the system or the method.

Non-patent publications have disclosed the use by Internet Service Providers of popup window advertisements. The user is able to dismiss the ads. An advertisement banner forms an integral part of many web pages, and the ad may be different each time the web page is opened. The user is not able to dismiss the banner ad, as it is an integral part of the web page being viewed. In one of the disclosed systems, the user can download and install a free toolbar that resides on the user's monitor and delivers, personalized news and other information to the desktop. The user receives news, stock prices, and the like on the toolbar in return for receiving an advertisement or series of advertisements. The user can dismiss the toolbar.

In each of these systems, the advertisement windows are ether dismissible or permanent. What is lacking in prior art advertising systems is a non-dismissible, pop-up advertisement window that is presented to the user for a predetermined time and then disappears. Also lacking are means for compensating the user for receiving the advertisements. Further lacking is an advertising system in which an advertisement's complexity is geared to the connection speed of the user.

The conventional Internet advertising model is based primarily on banner advertising. Rates are based on Internet Service Provider traffic or, in the case of click-through banner ads, on the viewer's willingness to leave the site and review the advertiser's content. This form of advertising oftentimes detracts from the site's content. It is difficult for advertisers to determine ad effectiveness; and the advertising form provides no monetary benefit to the viewer. For click-through banner advertising to be successful, viewers must follow the link to the advertiser's site. Such a process is clearly counterproductive to the content provider's objectives.

Currently Advertisers and Internet Service Providers are presently unable to capitalize fully on the growing popularity of the Internet. Banner ad loading can be slow and interferes with the viewing of content, adversely affecting the very audience both advertiser and content provider seek to attract. The keyword selection method of banner advertisements does not provide an attractive mechanism for general brand advertisers to place their message in front of a demographically qualified audience. In addition, present advertising systems provide no comprehensive means for compensating the advertisement viewer.

The Internet allows a unique interaction amongst the Internet Service Provider, the advertiser and the advertisement viewer. Conventional advertising systems have as yet not fully capitalized on the opportunities afforded by this interaction.

### SUMMARY OF THE INVENTION

The present invention provides an advertising system that significantly benefits each of the Internet Service Provider, the advertiser and the advertisement viewer. In addition, the system provides a marketing medium that delivers advertisements in a manner which doesn't detract from the viewers system use, program use or Internet content, and which is much more receptive to the highly desirable viewer demographic.

Advantageously, the advertisement delivery system provides a reliable outlet for consumer oriented branding campaigns and mainstream advertisers; increased revenue for Internet Service Providers; and cash compensation for advertisement viewers. Compensation of ad viewers helps to overcome the public's ambiguous attitude towards advertising. Internet Service Providers are better able capitalize on the growing viewer market, and advertisers are able to more effectively communicate with consumers.

Generally stated, the present invention provides a system and method for placing an advertisement on the monitor of a user of an Internet Service Provider. The user has an election to register. A user that has registered is compensated for viewing the advertisement. An application logic set is housed on a server. Once the user logs on to the Internet through the Internet Service Provider, the server delivers a modified web browser window adapted to “pop up” containing an advertisement. The ad size is adjustable but has default sizes that depend on which ad option is utilized. An ad screen will open after a specified period of time that is adjustable, but will default to 15-20 seconds. Upon conclusion of the preselected time period, the window will close. By offering different ad location options on the monitor, the Internet Service Provider is able to customize the look and feel of the ad delivery. The ad sent is determined by an analysis of the user's system capability. For example, users with high-speed connections and adequate system speed are presented with a full multimedia advertisement while those with slower connections and/or system speed receive ads that download quickly and run efficiently on their systems. The user has no control over the ad window; is unable to minimize, close or move the ad. The user does have an option to register, which is accessed by clicking on the “register now” button. While the ad is open the user may elect to receive additional information in the form of a one-time emailing by clicking on the “more info” button. The system can be set to open additional ads at predetermined intervals.

Advertisements are displayed in several ways. Among these are the following display examples: (i) different ads are rotated throughout each time period. That is to say, the first person to access the Internet Service Provider in a particular time period would see ad A, while the second would see ad B and so on; (ii) ads are displayed in a series. A sequential series of ads is adapted to “follow” a user. This allows an advertiser to build a brand relationship with the consumer regardless of whether the user is viewing a web site or is logged onto the Internet for another reason. Ad delivery can be specific to the demographic information provided by the user. The control over ad delivery allows advertisers to maximize the effectiveness of their ad campaigns, thus providing Internet Service Providers the ability to maximize their advertising revenue.

More specifically, the system comprises an Internet server having at least one application logic set stored thereon. Each application set is provided with means for causing the browser program installed on the users computer to display an advertisement in a non-dismissible and temporary browser window on the user's monitor. The system also comprises a registered user database on the server for storing user information and computing and storing the user's advertisement viewing history. When a user logs onto his Internet Service Provider, the user's computer is caused to access an application logic set on the server, thereby triggering display of an advertisement in a temporary and non-dismissible window on the monitor. Alternately, when a user logs onto his Internet Service Provider, the ISP is caused to access an application logic set on the server thereby triggering display of an advertisement in a temporary and non-dismissible window on the user's monitor.

Further, the invention provides a method for advertising to a user of an Internet Service Provider. A user accesses the Internet via the Internet Service Provider. The application logic set sends an advertisement to be displayed on the user's monitor. The user has an election to register. Next, the advertisement is displayed in a browser window on the monitor of the user. The window is temporarily displayed and it is non-dismissible. Compensation is provided to the user for receiving the advertisement once said user registers. This compensation typically takes the form of free access or cash payments, but can be provided by many other mechanisms. Typical compensation mechanisms which are suitable for this purpose include cash payments, free services, software or hardware, redeemable coupons or credits for access time or services deliverable directly to the user's computer, and the like.

The invention allows medium and large-scale advertisers to place a message before a large, demographically qualified audience. It provides much needed revenue directly to high and moderate volume Internet Service Providers. Like television advertising, this present direct advertising system makes use of an Internet Service Provider as a platform from which to broadcast an advertisers message. Unlike television, it additionally provides a means for accurately tracking ad impressions by viewers and compensates those viewers that have registered.

Ads open and close automatically, are of short duration, and remain unobtrusive to the viewer. User objection and interference with computer use or site content are minimized. The temporary nature of the ads captures the attention of the viewer, giving each message more impact.

Ad display is based on the user's system capacity and access speed. Hence, efficiency of ad loading is maximized. The user cannot control the ad window. Advertisers are thereby assured that ads will be viewed. Once registered, users are compensated for the ads they view. In addition, the Internet Service Provider is paid on the basis of ads viewed. Billing of advertisers is based on actual ad viewing, not estimated user statistics. Demographic information from users allows advertisers to custom tailor ad campaigns and product presentations.

### BRIEF DESCRIPTION OF DRAWINGS

The invention will be more fully understood and further advantages will become apparent when reference is had to the following detailed description and the accompanying drawings, in which:

FIG. 1 is a schematic representation of the various elements of present direct Internet advertising system;

FIG. 2 is a block diagram depicting the method of the present invention;

FIG. 3 is a schematic representation depicting an alternate embodiment of the method of FIG. 2 integrated with the elements of the system of FIG. 1; and

FIG. 4 is a block diagram illustrating optional steps for practicing the method of the present invention.

### DESCRIPTION OF THE PREFERRED EMBODIMENTS

The present invention provides a system and method for placing an advertisement on the monitor of a user of an Internet Service Provider.

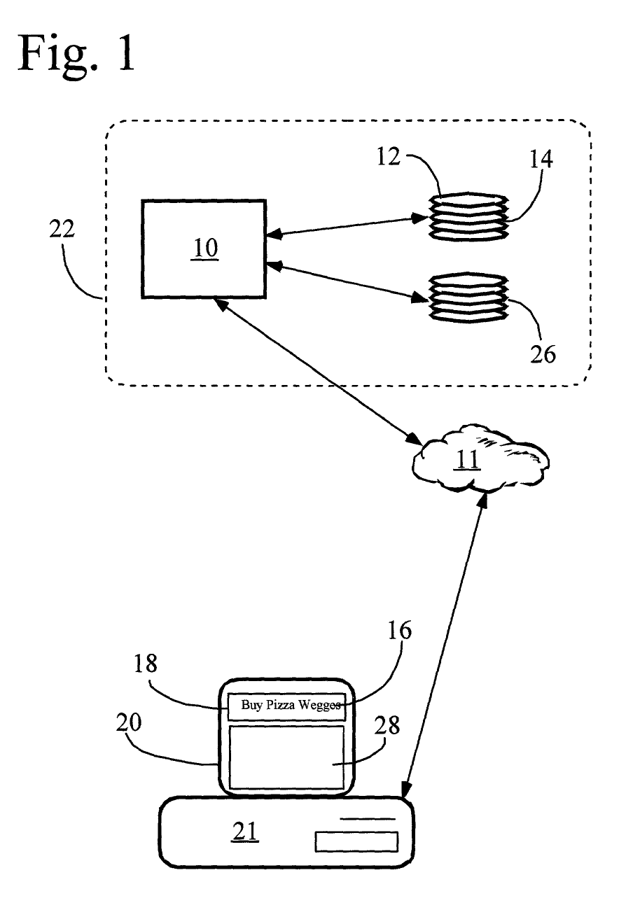

Specifically, as shown in FIG. 1, the system comprises a server 10 connected to the Internet 11 and at least one application logic set 12 stored in memory 14 on the server 10. As used herein, the term “connected” means a conventional wired connection as would be provided by a modem and telephone line, cable modem, T connection or the like or, alternatively, a wireless connection, such as that provided by a wireless modem, cell phone, PDA or the like. Each application logic set 12 is provided with means for causing the browser, operating from the user's computer 21, to display the advertisement 16 in a non-dismissible and temporary browser window 18 on the monitor 20 of the user. The means for causing the browser to display advertisement 16 is accomplished by the application logic set 12 sending web page mark-up language code containing the advertisement 16. Code applicable for this purpose typically comprises HTML, Java Applets, Flash routines, or similar web page construction code. It optionally includes animation, images, or sound. As a further option the application set 12 includes code for a series of different advertisements. The code specifies the size and position of window 18 as well as how long the window is viewable. The predetermined time within which the window is viewable can vary depending upon default settings, type and length of advertisement, Internet Service Provider's preference and the like. Typically, the predetermined time period for viewing window 18 ranges from about 10 seconds to 60 minutes, preferably from about 15 to 40 seconds, and more preferably from about 20 to 30. Optionally, the advertisement is delayed for a period of time before being sent to the user. The system additionally includes a user database 26 on the server 10 for storing user information, and computing and storing the user's advertisement viewing history. When a user accesses the Internet via the Internet Service Provider, the user's browser is caused to access an application logic set 12 on the server 10, thereby triggering display of the advertisement 16 displayed in a temporary and non-dismissible window 18 on the user's monitor 20. Alternately, when a user accesses the Internet via the Internet Service Provider, the application logic set 12 on server 10 is caused to access the browser program installed on the users computer, thereby triggering display of the advertisement 16 displayed in a temporary and non-dismissible window 18 on the user's monitor 20

Registered user database 26 of server 10 contains demographic information for each user, so that advertisements sent to the user are relevant and of interest to the user. A log containing the type and number of advertisements viewed and other relevant data is also stored for each user.

As a further option, the application logic set 12 is provided with means for determining the connection speed of the user and selecting an advertisement type that best matches the connection speed. With this embodiment, users having high-speed connections are presented with full multimedia advertisements, while users having slower connection speeds receive advertisements that are less multimedia intensive and download quickly. The connection speed is defined herein as the combined Internet connection speed as well as the processor speed of the user's computer.

The advertisement window 18 is non-dismissible; that is to say, the user is unable to eliminate the window 18. Preferably, window 18 fills the top half of the user's monitor. Alternatively, the window location can be determined based on the purpose of the advertisement. Further alternatively, advertisement 16 is presented between user viewed web pages or program use.

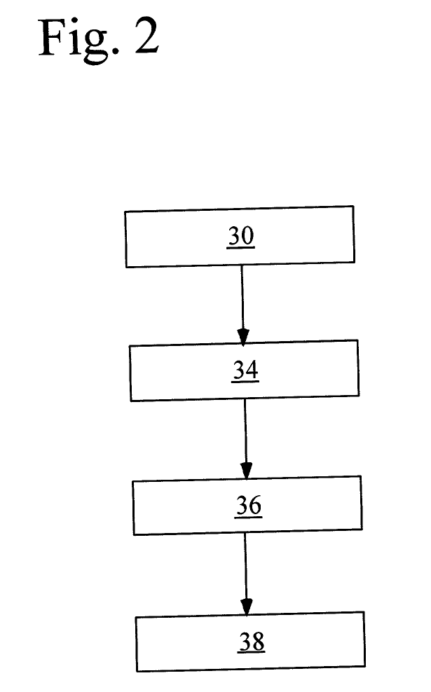

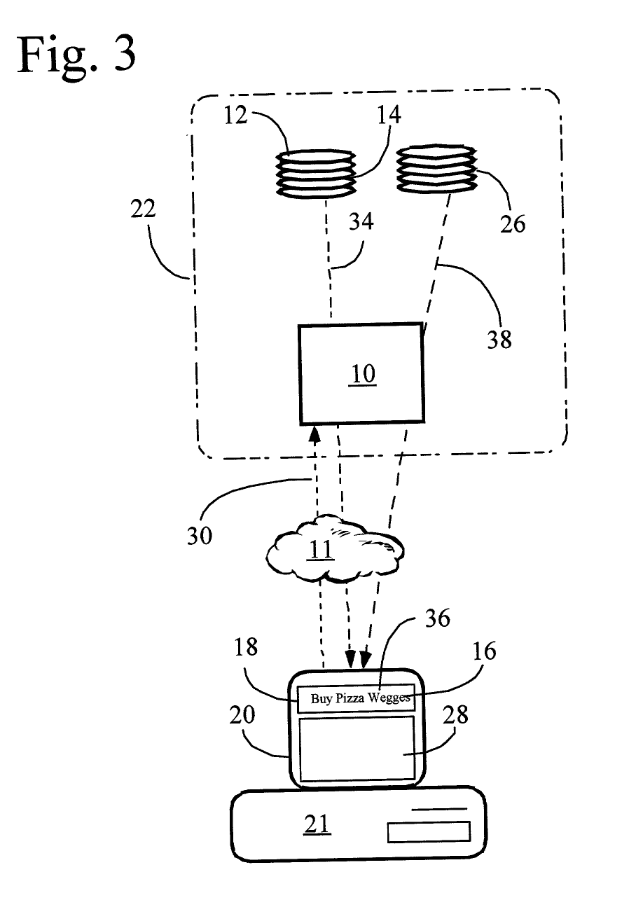

Also provided by the invention is a method for advertising to a user of an Internet Service Provider having the features shown in FIGS. 2 and 3. During practice of the method, a user accesses 30 an Internet Service Provider 22 having at least one application logic set 12 connected to server 10. Thereupon, an advertisement is sent 34 to the user. A browser window 18 opens on the monitor 20 of the user; advertisement 36 is displayed therein. The window 18 is non-dismissible and viewable for a predetermined time period, preferably 20-30 seconds. Compensation 38 is provided to the user for receiving the advertisement. The amount of compensation can vary depending on the total number of advertisements viewed by the user. Compensation can be achieved using a variety of forms, including redeemable coupons, credits for access time or service deliverable directly to the user's computer, free hardware or software, and the like. A further mechanism that is especially suited for this purpose comprises compensation having the form of cash rewards.

Preferably, the advertisement sent 34 to the user fills the top half of the monitor over the top of the operating system desktop, any open program or a viewed web page 28. Alternatively, the advertisement window 18 is sent 34 after the user closes a program or moves from the viewed page 28, but before the new page or program is loaded. As a further alternative, a series of advertisements is sent 34 to the user. Optionally, display of the advertisement is delayed for a predetermined time period.

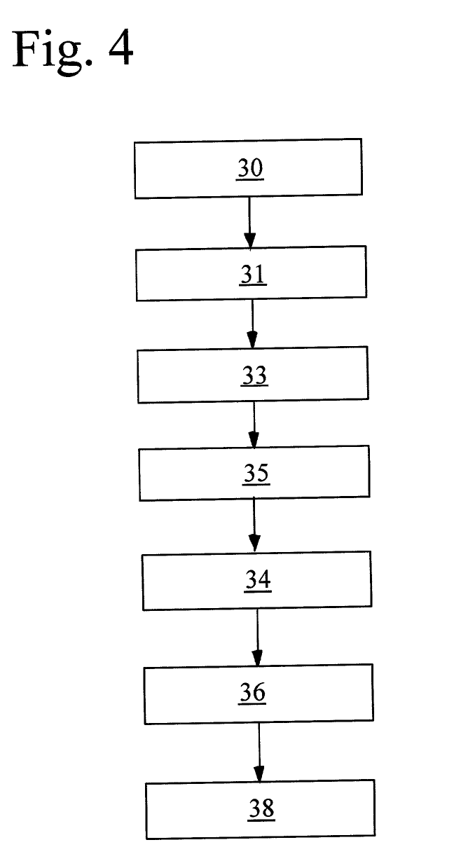

In FIG. 4 there is shown a direct Internet advertising method to which the steps of (i) determining 31 the connection speed of the user; and (ii) selecting 33 an advertisement type appropriate for the connection speed have been added. The connection speed is defined herein as the combined speeds of: (a) the Internet connection speed and (b) the processor speed of the user's computer. As a further option, the advertisement is matched 35 to the profile stored in the registered user database 26.

Having thus described the invention in rather full detail, it will be understood that such detail need not be strictly adhered to, but that additional changes and modifications may suggest themselves to one skilled in the art, all falling within the scope of the invention as defined by the subjoined claims.

We claim:

1. A system for placing an advertisement on the monitor of a subscriber of an Internet Service Provider, comprising:
a) an Internet server;
b) at least one application logic set stored on said server, each of said application logic sets being provided with means for causing a browser of a user to display said advertisement in a non-dismissible and temporary browser window on said monitor;
c) a registered user database on said database for storing user information and computing and storing the user's advertisement viewing history,
whereby access by said user of said Internet Service Provider triggers display of said advertisement in a temporary and non-dismissible window on said monitor.

2. A system as recited by claim 1, wherein said application logic set is further provided with means for determining the connection speed of said user and selecting an advertisement type best matched therewith, so that users having high-speed connections are presented with full multimedia advertisements while users with slower connection speeds receive advertisements that are less multimedia intensive and download quickly.

3. A system as recited by claim 1, wherein said user's monitor has a top half, and said advertisement is presented in a browser window filling the top half of the monitor.

4. A system as recited by claim 1, wherein at least one application set comprises means for generating a series of advertisements in a non-dismissible and temporary browser window on said monitor.

5. A system as recited by claim 1, wherein at least one application set further comprises means for delaying display of said advertisement for a predetermined time period.

6. A system as recited by claim 1, wherein said web site has at least one page comprising a register button adapted to be placed in an “on” condition to thereby provide a registration window for receiving user's demographic information.

7. A system as recited by claim 1, wherein said web site has at least one page comprising a “more information” button adapted to be placed in an “on” condition, thereby initiating a one time emailing of additional information concerning the advertisement to the user, said information containing additional links to the advertising company's website, or for purchase of coupons and/or other purchase incentives.

8. A method for advertising to a user of an Internet Service Provider, comprising the steps of:
a) accessing said Internet Service Provider;
b) sending an advertisement to said user;
c) displaying said advertisement in a browser window on a monitor of said user, said window being non-dismissible and temporary; and
d) compensating said user for receiving said advertisement provided said user has previously registered.

9) A method as recited by claim 6, wherein said display of said advertisement is delayed for a predetermined time.

10) A method as recited by claim 6, wherein said advertisement comprises a series of advertisements.

11) A method as recited by claim 6, wherein said monitor has a top half, and said window fills the top half of said monitor.

12) A method as recited by claim 6, further comprising the step of displaying said advertisement window occurs after the user moves from one page or program to another.

13) A method as recited by claim 6, further comprising the step of displaying said advertisement window occurs after the user closes a program on their computer.

14) A method as recited by claim 6, wherein the step of displaying said advertisement window is delayed for a predetermined time.

15. A method as recited by claim 6, wherein steps “b”, “c” and “d” are replaced by steps “B”, “C”, “D” and “E”, which comprise:
B) matching an advertisement to a profile stored in a registered user data base;
C) sending said matched advertisement to said user;
D) displaying said matched advertisement in a browser window on a monitor of said user, said window being non-dismissible and temporary; and
E) compensating said user for receiving said advertisement.

16. A method as recited by claim 6, wherein said user has a computer having a processor speed, a monitor and a connection speed defined by the sum of the user's Internet connection speed and the processor speed of said computer, and steps “b”, “c” and “d” are replaced by steps “B”, “C”, “D”, “E” and “:F”, which comprise:
B) determining the connection speed of said user;
C) selecting an advertisement type appropriate for said connection speed;
D) sending said selected advertisement to said user;
E) displaying said advertisement in a browser window on the monitor of said user, said window being non-dismissible and temporary; and
F) compensating said user for receiving said advertisement.

17. A method as recited by claim 13 wherein steps “b” and “c” are replaced by steps “B” and “C”, which comprise:
B) determining the connection speed and computer type of said user; and
C) selecting an advertisement type appropriate for said connection speed and said computer type.

18. A method as recited by claim 2, wherein said connection is wireless.

19. A method as recited by claim 14, wherein said connection is wireless.
